(19) United States
(12) Patent Application Publication
(10) Pub. No.: US 2010/0051183 A1
(43) Pub. Date: Mar. 4, 2010

(54) METHOD OF MAKING LIGHTWEIGHT STRUCTURES

(75) Inventors: Johannes Böke, Blomberg (DE); Marko Maciej, Paderborn (DE); Florian H. Gojny, Thierhaupten (DE); Christian Howe, Paderborn (DE); Sebastian Grasser, Friedberg (DE); Bernd Wohletz, Meitingen (DE); Gerhard Heilmeier, Meitingen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler SGL GmbH & Co. KG, Paderborn (DE)

(21) Appl. No.: 12/546,370

(22) Filed: Aug. 24, 2009

(30) Foreign Application Priority Data
Aug. 27, 2008 (DE) 10 2008 039 869.1

(51) Int. Cl. C09J 5/06; B32B 38/04; B29C 65/02

(52) U.S. Cl. 156/228; 156/322; 156/256

(57) ABSTRACT

In a method of making a lightweight structure composed of a reinforced base element and a reinforcement element, the reinforcement element is fabricated, and the base element is heated by a heat source to a curing or pre-curing temperature. Subsequently the heated base element is joined together with the reinforcement element in a press tool.

### CROSS-REFERENCES TO RELATED APPLICATIONS

This application claims the priority of German Patent Application, Serial No. 10 2008 039 869.1, filed Aug. 27, 2008, pursuant to 35 U.S.C. 119(a)-(d), the content of which is incorporated herein by reference in its entirety as if fully set forth herein.

### BACKGROUND OF THE INVENTION

The present invention relates to a method of making lightweight structures or fiber-reinforced structures.

The following discussion of related art is provided to assist the reader in understanding the advantages of the invention, and is not to be construed as an admission that this related art is prior art to this invention.

Any single component of motor vehicles adds weight and thus adversely affects fuel consumption. Thus, the automobile industry tries to design the respective components as lightweight as possible while still complying with the demands on component properties such as, e.g., strength, stiffness and service life.

Against the background of climate change and resultant CO₂ discussion, the need for lightweight construction gains more and more importance in the automobile industry. In particular fiber-reinforced plastics show great potential when used for structures of sufficient strength and stiffness in order to significantly reduce the body weight. There is a need in the automobile industry for a number of such components, i.e. a large-scale production of fiber-reinforced structures. Still, there is a lack of a suitable production process that allows a large-scale production of such fiber-reinforced structures at suitable clock time. The reason for that is the need for numerous manual activities which are very time-consuming. Also, curing of matrix resins used during production of these components is time-consuming. One production method involves prepreg pressing for example. The term “prepreg” stands hereby short for “pre-impregnated fibers” and relates to a semi-finished product comprised of continuous filaments or long fibers and a thermoplastic or uncured matrix of thermoset material. This results in component-based clock times of about 30 minutes. Another approach is the so-called RTM process (Resin-Transfer-Molding).

It would therefore be desirable and advantageous to provide an improved of making lightweight structures or fiber-reinforced structures to obviate prior art shortcomings and to allow efficient large-scale production.

### SUMMARY OF THE INVENTION

According to one aspect of the present invention, a method of making a lightweight structure includes the steps of fabricating a reinforcement element, heating a base element by a heat source to a curing or pre-curing temperature, and joining the heated base element with the reinforcement element in a press tool.

According to another aspect of the present invention, a method of making a lightweight structure includes the steps of fabricating a reinforcement element, applying adhesive to the reinforcement element and/or a base element, separately forming and curing the reinforcement element, and joining the base element with the reinforcement element in a press tool.

Currently preferred is the production of lightweight structures, i.e. fiber-reinforced structures, by the so-called prepreg pressing technique. Fabrication of the stack of prepregs is executed in a continuous process by means of calenders and cutters and has short clock times in the range of few seconds. In order to realize an efficient utilization of the plant engineering, the fabricating step is advantageously decoupled from the time-intensive forming and curing processes.

The term “prepreg” is used in the disclosure as relating to all semi-finished products of thermoset fiber-matrix such as BMC (bulk molding compound) or SMC (sheet molding compound) as well as textile products (fabric and non-woven fabric), staple fibers and non-woven.

A stack of prepregs can advantageously be produced by using a multi-stage process, involving a joining of two prepregs in a first stage through calendering and a calendering in successive stages a number of prepregs per stage in accordance with a required wall thickness of the lightweight structure. Currently preferred is a calendering of one or two more prepregs per stage. Of course, separation films are removed from the prepregs before entry into the respective calender.

The calendered prepregs may then be advantageously coated on their top side and bottom side. Examples of a coating include a non-stick film and non-woven layer. It is also conceivable to attach a non-stick film to the top and bottom sides of the prepreg. A configuration with non-stick films on both sides is suitably provided when separately producing the reinforcement elements so as to avoid adherence to the ram and female mold of the press tool. It is also possible to provide on one of both sides a non-woven layer when direct pressing-in and/or combined pressing-in and bonding are involved. A non-stick film can advantageously be attached to the other side.

When compressed in the press tool, the non-woven layer is impregnated by the matrix resin so that the latter may serve as adhesive, with the layer next to the non-woven layer being made to be rich in resin.

After calendering the stack of prepregs and coating their surface, the respective stack is cut to size to the desired geometry. This can be done for example by a stamping device or a cutter. As different lightweight structures can be produced, each blank can be cut to a different geometry. Of course, when a large-scale production is involved, series of same blanks, i.e. same geometry, should be produced first. As a result of the advantageous surface coating of the prepreg, tool contamination is eliminated. The finished blanks are stacked in a special charge carrier.

The production of lightweight structures or fiber-reinforced structures may be realized by directly pressing the blanks into the base elements to be reinforced. It is, of course, also conceivable, to apply an adhesive onto the blanks so as to realize a combination of pressing and bonding instead of direct pressing-in. In addition to both these process variants, the base element to be reinforced can be placed in a heating station before being deposited in the press tool. An example of a heat source includes an IR radiation field which is placed upstream of the press tool. When being placed in the heat station, the base element to be reinforced is heated, preferably within few seconds, to curing temperature of the resin and then transferred to the press tool which is heated conventionally. In this way, a time-intensive heating of the base structure to be reinforced with accompanying slower curing or pre-curing of the prepreg is avoided.

According to another feature of the present invention, the reinforcement element can be produced separately by forming and curing the stack of prepregs or blanks in an additional heated tool. In this procedure, both sides, i.e. top and bottom sides of the prepreg stack are provided with a non-stick film. The blanks formed in this way are stacked in a second special charge carrier. These formed blanks can then advantageously bonded into the base element to be reinforced by applying adhesive onto the formed blanks or onto the base elements to be reinforced. The components are compressed in the press tool. Advantageously, the press tool is heated when, e.g., a heat-curing adhesive is used. When providing the formed blanks with adhesive, it may be suitable to clean and activate the formed blanks before application of the adhesive. This may be realized with a plasma cleanser.

Suitably, the process variants with adhesive application can advantageously be used when the demanded mechanical properties of the lightweight structure or fiber-reinforced structure cannot be reached by means of the matrix resin (direct pressing-in).

The thus-produced lightweight structures or fiber-reinforced structures are removed from the press tool in all process variants and stacked in a charge carrier.

In principle, the stacks of prepregs or prepreg layers are calendered onto one another under load considerations in a number needed for the reinforcements. The uppermost and lowermost layer may hereby be formed by non-stick films or by a non-stick film on top and a non-woven layer on the bottom. The presence of non-stick films facilitate transport and prevent tool contamination used in the process. The non-woven layer serves the same purpose but in addition may also serve as carrier or spacer for the adhesive layer because the non-woven layer becomes impregnated with resin during pressing so that the layer next to the non-woven should be made rich in resin. The stack of prepregs may be formed in a press tool and cured in accordance with a process variant, whereby appropriate selection of the resin system and curing temperature enables realization of curing or pre-curing sufficient for consolidation within e.g. five minutes.

According to another process variant, the base elements to be reinforced are heated to the curing or pre-curing temperature of the matrix resin by a heat source so as to avoid prolonged heating times in the tool.

According to another advantageous feature of the present invention, the base element may be made of metal, e.g. steel sheet.

A method according to the invention can thus be executed through implementation of the following steps:

Initially, a stack of prepregs can be built up successively by a preferably multi-stage process, wherein at least two prepregs are combined in a first stage and one or two more prepregs are calendered per stage in subsequent stages in accordance with the required wall thickness of the reinforced base element.

In a second step, the produced stack of prepregs is surface-coated (bottom side and top side) by applying a non-stick film on both sides or on only one side, preferably the top side, and applying a non-woven layer on the other side, preferably the bottom side, with the prepreg layer neighboring the non-woven being made preferably rich in resin.

In a third step, the stack is transferred to a trimming device (cutter) and cut to the required geometries.

In a fourth step, the blanks are stacked in a special charge carrier.

In a fifth step, the blanks are for example grabbed by a vacuum gripper and placed in a press tool in which the base element to be reinforced is deposited, whereby the base element, before being deposited in the press tool, is exposed to a heat station, e.g. an IR radiation field, and heated to curing temperature of the resin. In the press tool, which may be heated, forming and curing takes place.

As an alternative to step five, adhesive may be applied onto the blanks (step 6) before the blanks are placed in the base element to be reinforced. Suitable application of adhesive avoids contamination of the produced structure or tools (press tool) as a result of the compressed material. Of course, the base elements to be reinforced are exposed to a heat source and heated to curing temperature analogous to step five.

It is also conceivable as an alternative to the steps five and six to produce the reinforcement elements separately (step 7) by forming and curing the blanks in a heated tool. Joining of the base element to be reinforced with the reinforcement element (blank) is then executed with an additional bonding process, with the adhesive being applied either onto the base element or onto the cleaned (preferably through plasma cleaning) reinforcement element (blank). The base element and the reinforcement element are joined together and cured in a press tool, which may be heated.

In an eight step, which either follows step five, six, or seven, the reinforced structures are removed from the press tool and stacked in a charge carrier for example.

In summary, a method of making lightweight structures or fiber-reinforced structures is made available which operates at clock times suitable for large-scale production.

Apart form the procedures described by way of example for producing fiber-plastic/steel composites through direct pressing-in and direct pressing-in with adhesive application, the binder resin or matrix resin, used for producing the prepreg, may be provided in the variation of direct pressing-in with modifiers which enable an optimized connection of the fiber-plastic composite with the base elements made of steel sheet. Through use of such a prepreg in the complete fiber-plastic portion or at least of such a prepreg layer, an otherwise required adhesive application can be omitted while still attaining good adhesion of the fiber-plastic composite upon the steel sheet.

The modification may involve additives which are used in adhesive production. Examples of additives include liquid rubber, carboxy-terminated butadiene acrylonitrile rubber, amine-terminated butadiene acrylonitrile rubber, core-shell materials (e.g. organically masked silicone rubber) as well as copolymers. Furthermore, particle modifiers such as silicate particles or carbon-based particles may be used in addition to the afore-listed modifiers. Unlike conventional adhesives, modified epoxy resins reach a stiffness of more than 2000 MPa.

The addition of 0.1-50% of the modifier component to the base prepreg resin or matrix resin, preferably 2-10%, currently preferred 4-9%, results in a significant increase of the matrix toughness while attaining a comparably great stiffness, strength, and heat resistance of the fiber-plastic composite portion. The modification leads to a significantly enhanced adhesion of the fiber-plastic composite onto the steel sheet so that the application of an adhesive layer and the associated process step can be eliminated.

For example, a modification of a solvent-free epoxy resin (bisphenol A diglycidyl ether), defined by an epoxy equivalent weight (EEW) of 260-280 eq/mol with 9% of a core-shell particle, can be carried out. Of course, other EEWs and resins may be used as well. The matrix resin may be cured with an aliphatic or aromatic amine hardener (advantageously dicyandiamide) as well as with further hardeners that are compatible with epoxy resin. In addition, the formulation contains advantageously an accelerator. Curing takes place at 80-180° C., preferably at 100-130° C., over a time period of 2-360 min, preferably over a time period of 15-90 min.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a fabricating process of stacks of prepregs;

FIG. 2 is a schematic illustration of a direct pressing-in process of reinforcements into the base element;

FIG. 3 is a schematic illustration of a combined pressing-in and bonding process;

FIG. 4 is a schematic illustration of a separate production process and following bonding process; and

FIG. 5 a sequence diagram of a method of making lightweight structures or fiber-reinforced structures in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

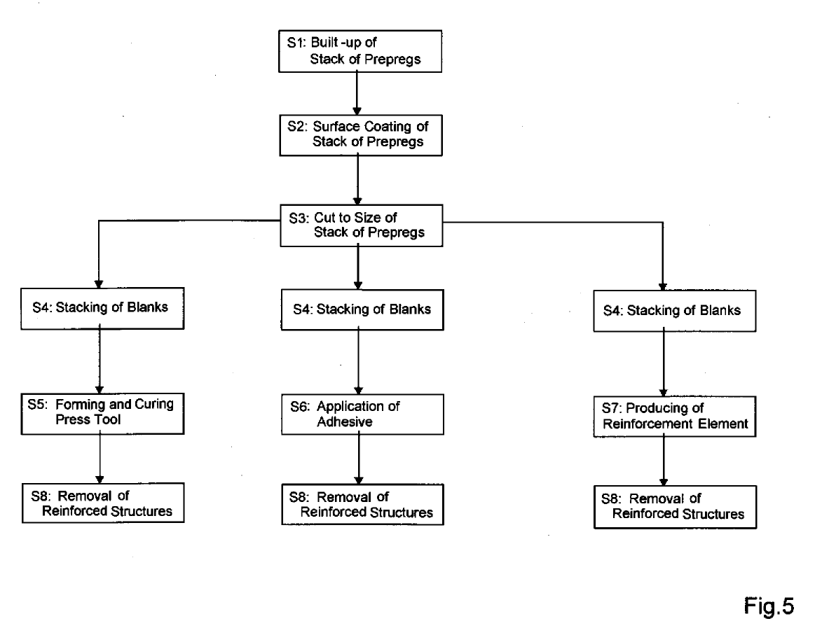

Turning now to the drawing, and in particular to FIG. 5, there is shown in general a sequence diagram of method steps S1 to S8 of a method for making lightweight structures or fiber-reinforced structures in accordance with the present invention. Steps S5 to S7 are hereby to be understood as an alternative embodiment.

Step S1: A stack of prepregs is built-up successively in a preferably multi-stage process, wherein at least two prepregs are joined together in a first stage and one or two more prepregs are calendered per stage in subsequent stages in accordance with the required wall thickness of the reinforced base element.

Step S2: In a second step, the produced stack of prepregs is surface-coated (bottom side and top side) by applying an non-stick film on both sides or on only one side, preferably the top side, and applying a non-woven layer on the other side, preferably the bottom side, with the prepreg layer neighboring the non-woven being made preferably rich in resin.

Step S3: In a third step, the stack is transferred to a trimming device (cutter) and cut to blanks with the required geometries.

Step S4: In a fourth step, the blanks are stacked in a special charge carrier.

Step S5: In a fifth step, the blanks are, for example, grabbed by a vacuum gripper and placed in a press tool in which the base element to be reinforced is deposited, whereby the base element, before being deposited in the press tool, is exposed to a heat station, e.g. an IR radiation field, and heated to curing temperature of the resin. In the press tool, which may be heated, forming and curing takes place.

Step S6: As an alternative to step five, adhesive may be applied onto the blanks (step 6) before the blanks are placed in the base element to be reinforced. Suitable application of adhesive avoids contamination of the produced structure or tools (press tool) as a result of the compression-molded material. Of course, the base elements to be reinforced are exposed to a heat source and heated to curing temperature analogous to step five.

Step S7: It is also conceivable as an alternative to the steps five and six to produce the reinforcement elements separately (step 7) by forming and curing the blanks in a heated tool. Joining of the base element to be reinforced with the reinforcement element (blank) is then executed with an additional bonding process, with the adhesive being applied either onto the base element or onto the cleaned (preferably plasma cleaning) reinforcement element (blank). The base element and the reinforcement element are joined together and cured in a press tool, which may be heated.

Step S8: In an eight step, which either follows step five, six, or seven, the reinforced structures are removed from the press tool and stacked in a charge carrier for example.

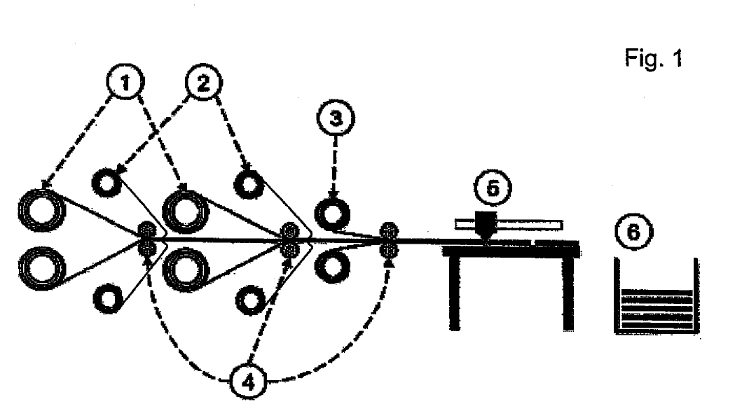

FIG. 1 shows the fabrication of the stack of prepregs. The semi-finished prepreg is used as rolled stock 1 and supplied via roll stands to a calender system 4. As the thickness of these semi-finished products is normally smaller than the wanted wall thickness of the fiber-reinforced structures, stacking of several layers is possible. The buildup of the stack is carried out successively by calendering two prepregs in a first stage onto one another and feeding to this structure one or two more prepregs in like manner in each of further stages, as shown by way of example. Separating films 2 are automatically removed after calendering.

Subsequently, the top and bottom sides of the stack are coated. A non-stick film 3 and/or a non-woven layer may for example be provided as coating. Non-stick films may be applied onto the top and bottom sides, or one of both sides may be provided with a non-woven layer, with the other side being provided with a non-stick film.

The presence of a non-stick film 3 on both sides is suitable for example when producing the reinforcement element separately in order to prevent adhesion to a ram and female mold of the press tool.

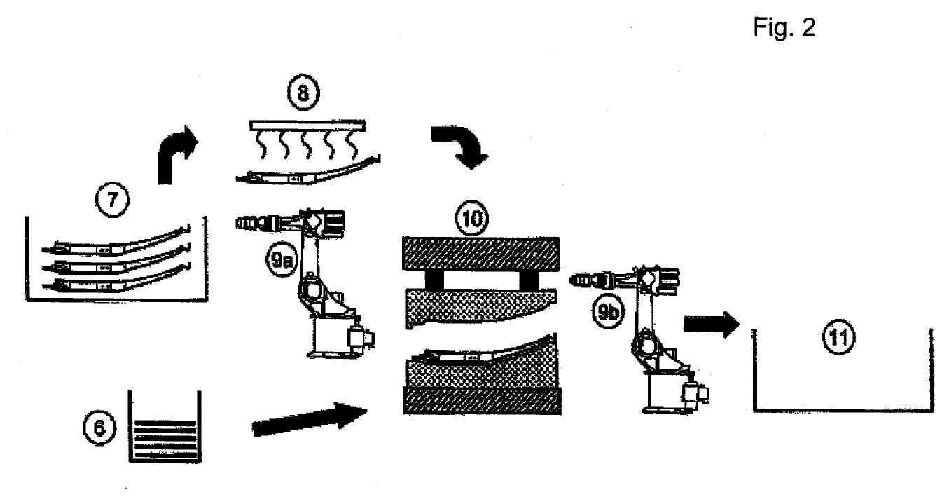

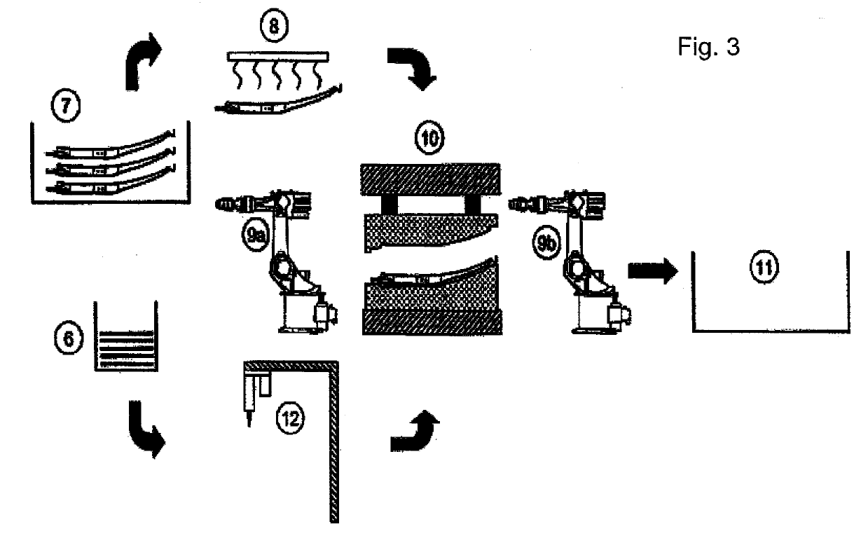

In the event of direct pressing-in (FIG. 2) or combined pressing-in and bonding (FIG. 3), one of the two sides is provided with a non-woven layer.

During pressing, the non-woven is impregnated by the matrix resin so that the latter may serve as adhesive, whereby the layer neighboring the non-woven should be made rich in resin.

Currently preferred is the application of a toughened matrix resin which resembles the characteristics of a crash-stable adhesive and is also similarly formatted so that the need for adhesives is eliminated as will be described further below.

As a result of the tackiness of the prepreg, the stack is geometrically stable while being dry to the outside as a result of the terminal non-woven layers and/or non-stick films. The stack can thus easily be transported by vacuum grippers for example.

The material for the non-stick films is advantageously selected such that a residue-free separation of the laminate is ensured from the forming tool even after the prepreg has cured at elevated temperatures of e.g. 180° C. The material is also selectable to provide a sufficient plasticity in order to prevent the formation of creases in the laminate during the forming process. Advantageously, the cyclical use of release agents in the tools can be eliminated.

Subsequently, the stack of prepregs is cut to the desired size. This step may be carried out by a stamping device or also by an automatic cutter 5. The configuration with upper and lower non-woven layers or non-stick films does not require any particular demands in order to avoid tool contamination. Thereafter, the blanks are stacked in a special charge carrier 6.

For example, the fiber-reinforced structures may be produced as B-pillars of motor vehicles. In the exemplary embodiment of the method according to the invention as shown in FIG. 2, the fiber-reinforced structures are manufactured directly by pressing the stack of prepregs into the base element. The matrix resin acts hereby as adhesive at the same time.

The invention is based on the recognition that prepregs of thermoset material require a heating over a relatively length time period in order to cure so that a sufficient clock time can be realized only by a multiply descending heated press tool. The curing speed can be increased through a rise in temperature whereby a particular material-specific time-temperature window may not be exceeded in order to prevent damage to the resin. In contrast thereto, the present invention has found that some thermoset matrix resins on epoxy basis cure enough at an object temperature of 180° C. within five minutes so as to establish a sufficient material consolidation. In order to utilize this short curing time it is contemplated to reach the object temperature as rapidly as possible by heating the base elements 7 with a heat source, for example an IR radiation field 8, within few seconds to the curing temperature of the resin and to place the base elements 7 by a handling robot 9a into the heated press tool 10. As a result of this advantageous procedure, a time-intensive heating of base elements to be reinforced with associated slower curing or procuring of the prepreg is avoided.

As an alternative to the afore-described procedures, application of the adhesive onto the prepregs to be formed is conceivable. Such a combined pressing and bonding process is shown by way of example in FIG. 3.

Adhesive is locally applied at 12 such that contamination of the tools and the structures during pressing is prevented, while still allowing adhesive application in sufficient amounts in order to realize a bonding across a largest possible area. Like in direct pressing-in (FIG. 2), the metallic base elements to be reinforced are heated by a heat source, e.g. implemented as IR radiation 8 field, to effect a curing as rapidly as possible.

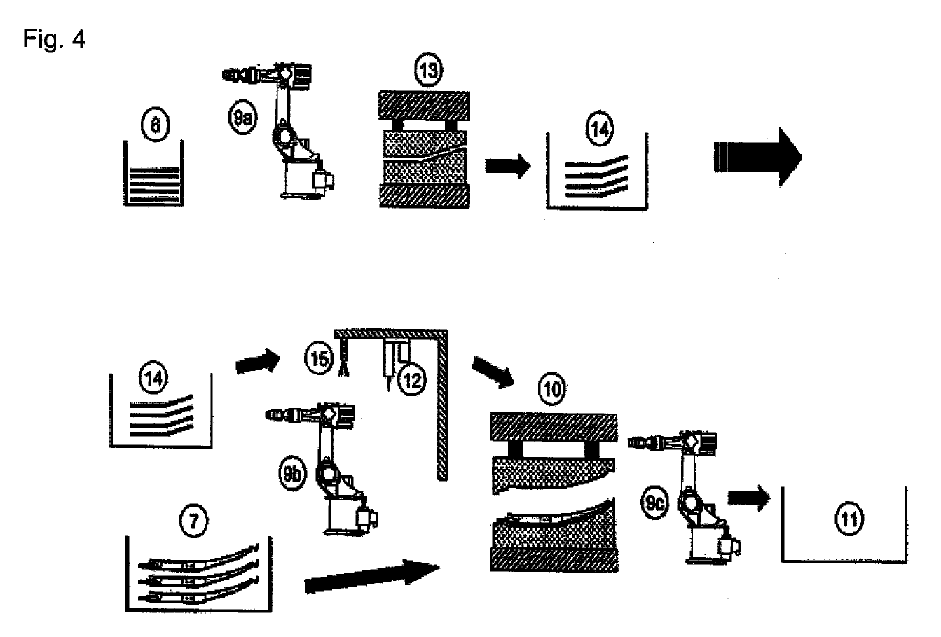

As shown by way of example in FIG. 4, the blanks, i.e. reinforcement elements, may also be produced separately by forming and curing the stack of prepregs in a heated tool 13. The thus formed blanks are stacked in a second special charge carrier 14. After demolding, the reinforcement elements are bonded into the base element to be reinforced by automatically applying adhesive at 12 onto the reinforcement elements or onto the base elements to be reinforced. Thereafter, both parts are compressed in the press tool 10. It is also possible to heat the press tool 10 when using a heat-curing adhesive. Suitably, the reinforcement elements are cleaned and activated by a plasma treatment 15 prior to adhesive application. Of course, this step may also be provided in the combined pressing and bonding procedures as described above with reference to FIG. 3.

The process variants with adhesive application are especially beneficial when the demanded mechanical properties cannot be realized via the matrix resin (direct pressing-in), although the use of modified matrix resin may be useable as will be described further below.

After compression in the press tool 10, the reinforced base elements are removed, suitably automatically, by a handling robot 9b (FIG. 2, 3) or 9c (FIG. 4) and stacked in a charge carrier 11. The handling robot 9b assumes in the embodiment of FIG. 4 the transfer of the individual elements past the treatment stations into the press tool 10. This task is assumed by handling robot 9a in the embodiments of FIGS. 2 and 3.

In addition to the exemplified procedures for producing fiber-plastic/steel composites through direct pressing-in (FIG. 2) and direct pressing-in with adhesive application (FIG. 3), in the process variant of FIG. 2, the binder resin or matrix resin, used for fabrication of the prepreg, may be modified to enable an optimized bond of the fiber-plastic composite with the steel sheet, i.e. base elements 7. The use of such a prepreg in the complete fiber-plastic portion or at least of such a prepreg layer allows elimination of the an otherwise required application of adhesive while still realizing a particularly good adhesion of the fiber-plastic composite to the steel sheet.

The modification may involve additives which are used in adhesive production. Examples of additives include liquid rubber, carboxy-terminated butadiene acrylonitrile rubber, amine-terminated butadiene acrylonitrile rubber, core-shell materials (e.g. organically masked silicone rubber) as well as copolymers. Furthermore, particle modifiers such as silicate particles or carbon-based particles may be used in addition to the afore-listed modifiers. Unlike conventional adhesives, modified epoxy resins reach a stiffness of more than 2000 MPa.

The addition of 0.1-50% of the modifier component to the base prepreg resin or matrix resin, preferably 2-10%, currently preferred 4-9%, results in a significant increase of the matrix toughness while attaining a comparably great stiffness, strength, and heat resistance of the fiber-plastic composite portion. The modification leads to a significantly enhanced adhesion of the fiber-plastic composite onto the steel sheet so that the application of an adhesive layer and the associated process step can be eliminated.

For example, a modification of a solvent-free epoxy resin (bisphenol A diglycidyl ether), defined by an epoxy equivalent weight (EEW) of 260-280 eq/mol with 9% of a core-shell particle, can be carried out. Of course, other EEWs and resins may be used as well. The matrix resin may be cured with an aliphatic or aromatic amine hardener (advantageously dicyandiamide) as well as with further hardeners that are compatible with epoxy resin. In addition, the formulation contains advantageously an accelerator. Curing takes place at 80-180° C., preferably at 100-130° C., over a time period of 2-360 min, preferably over a time period of 15-90 min.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a lightweight structure, comprising the steps of:
fabricating a reinforcement element;
heating a base element by a heat source to a curing or pre-curing temperature; and
joining the heated base element with the reinforcement element in a press tool.

2. The method of claim 1, wherein the fabricating step includes the step of calendering at least two prepregs.

3. The method of claim 1, wherein the fabricating step includes the step of surface coating a top side and a bottom side of the reinforcement element.

4. The method of claim 3, wherein the surface coating is implemented as at least one of a non-stick film and non-woven layer.

5. The method of claim 1, wherein the fabricating step includes the step of cutting the reinforcement element to size.

6. The method of claim 1, wherein the heat source is an IR radiation field.

7. The method of claim 1, wherein the joining step includes the step of pressing the reinforcement element directly into the base element.

8. The method of claim 1, wherein the joining step includes the steps of applying adhesive onto the reinforcement element and compressing the reinforcement element with the base element in the press tool.

9. The method of claim 2, further comprising the step of fabricating the prepregs by modifying a matrix resin through addition of a modifying agent to obtain a toughened matrix resin, with the addition of modifying agent amounting to 0.1-50% relative to the matrix resin.

10. The method of claim 9, wherein the modifying agent is added at an amount of 2-10%.

11. The method of claim 9, wherein the modifying agent is added at an amount of 4-9%.

12. The method of claim 1, wherein the base element is made of metal.

13. The method of claim 1, wherein the base element is made of sheet steel.

14. A method of making a lightweight structure, comprising the steps of:
fabricating a reinforcement element;
applying adhesive to at least one of the reinforcement element and a base element;
separately forming and curing the reinforcement element; and
joining the base element with the reinforcement element in a press tool.

15. The method of claim 14, wherein the fabricating step includes the step of calendering at least two prepregs.

16. The method of claim 14, wherein the fabricating step includes the step of surface coating a top side and a bottom side of the reinforcement element.

17. The method of claim 16, wherein the surface coating is implemented as at least one of an non-stick film and non-woven layer.

18. The method of claim 14, wherein the fabricating step includes the step of cutting the reinforcement element to size.

19. The method of claim 14, further comprising the step of forming and curing the reinforcement element in a tool.

20. The method of claim 14, further comprising the step of cleaning the reinforcement element before the applying step.

21. The method of claim 14, wherein the base element is made of metal.

22. The method of claim 14, wherein the base element is made of sheet steel.
